(19) United States
(12) Patent Application Publication
(10) Pub. No.: US 2009/0119113 A1
(43) Pub. Date: May 7, 2009

(54) Unit-Based Refuse Collection System

(75) Inventor: Mark A. DANCY, Murrells Inlet, SC (US)

Correspondence Address: CROWELL & MORING LLP;INTELLECTUAL PROPERTY GROUP, P.O. BOX 14300, WASHINGTON, DC, 20044-4300, US

(73) Assignee: Phoenix Recycling, Inc., Murrells Inlet, SC (US)

(21) Appl. No.: 11/934,383

(22) Filed: Nov. 2, 2007

(51) Int. Cl. G06Q 30/00; B65D 1/40

(52) U.S. Cl. 705/1; 220/495.01

(57) ABSTRACT

A method and system for unit-based refuse collection is described. The method includes providing a resident or user with visually identifiable, and in some cases standard-sized bags to contain the refuse to be collected, and providing the resident with a container for holding filled bags while awaiting collection, the container having at least one substantially transparent portion for observing the filled bags therein. While collecting the refuse, an operator visually determines compliance with the collection system by observing the filled visually identifiable bags through the substantially transparent portion or portions of the container, to ensure usage of the proper bags, which may be sold at a price including the cost of collection. The resident is then billed in accordance with the amount of refuse that is generated, reflected by the number of visually identifiable bags that are used.

### BACKGROUND OF THE INVENTION

The present invention relates to methods and systems for collecting refuse that are sustainable and which promote a reduction in the amount of refuse being discarded.

Typical refuse collection systems that are used in residential settings are financed using what is essentially flat fee, which is collected through property taxes or some other collection arrangement. Under these methods, the residents pay the same amount regardless of how much or how little refuse they generate and is removed by the municipality or by the refuse removal company.

In conventional systems, the collection of refuse is often done primarily manually, in which case a worker loads the refuse in a collection vehicle. More automated systems are also used, in which remotely operated arms or other systems lift carts containing the refuse and unload them in the vehicle.

### SUMMARY OF THE INVENTION

The exemplary embodiments of the present invention provide a system and method for the removal of refuse in a community, which promotes recycling and a reduction in the volume of refuse that is generated and discarded by the residents of the community.

Instead of charging a flat fee regardless of the amount of refuse generated by residents, it is becoming common in many communities to utilize programs that treat refuse removal the same way as other utilities, such as electricity and water supply. In these programs, the resident or other user of the service is charged depending on the amount of refuse that is generated, and thus has to be removed by the municipality or by the refuse hauling contractor.

According to these programs, referred to as unit pricing, variable-rate pricing or pay-as-you-throw programs (PAYT), residents are charged for the collection of municipal solid waste—ordinary household thrash—based on the amount that they throw away. These programs are preferred, because they create economic incentives for the residents to generate less waste and to recycle more.

This approach is beneficial from a financial point of view, because the municipalities can charge for refuse removal depending on the amount of refuse that is actually discarded, rather than attempting to guess the overall volume of refuse that needs to be removed and charging all residents a portion of that cost. It is also beneficial from an ecological point of view, because to reduce the cost of refuse removal, each household will likely minimize the waste generated, and will tend to recycle more.

PAYT programs have been adopted by many cities and communities across the United States, and have been supported, for example, by the Environmental Protection Agency as a useful tool to promote recycling and reduce the volume of refuse being discharged in landfills across the country. This latter benefit is particularly important, because projections predict that current landfills will reach capacity in the near future, and there is a general opposition in most communities to building new landfills.

PAYT programs provide multiple benefits to the communities that adopt them. For example, increased environmental sustainability results, since those communities typically report significant increases in recycling and comparable reductions in waste, due in large part to the economic incentives provided by the program. Less waste and more recycling result in that fewer natural resources need to be extracted and processed. Greenhouse gas emissions associated with the manufacture, distribution, use and subsequent disposal of products are reduced, in part as a result of increased recycling and waste reduction. PAYT programs thus are environmentally friendly.

PAYT is also an effective tool for communities struggling to cope with soaring expenses for municipal waste management. Well designed programs generate sufficient revenues to pay for the cost of solid waste removal. In addition, these programs may also pay for complementary services, such as recycling and composting. Residents also benefit, because they are able to take control of their waste removal bills, and may even significantly reduce them.

One of the greatest advantages of variable-rate programs modeled after the PAYT system is their inherent fairness. When the cost of managing refuse is hidden in taxes or is charged as a flat rate, those residents who recycle and reduce their waste in effect subsidize their more wasteful neighbors. When programs such as PAYT are implemented, residents only pay for removal of the waste that they generate.

In a typical unit pricing program for municipal waste, residents are charged a fee for each container or bag of waste that is generated and removed. A majority of communities have adopted automated refuse collection systems, in which large carts, for example the 64-96 cart, are used as containers or receptacles for the refuse, until it is collected. In these automated systems, handling by the human workers is minimized, and often limited to rolling the cart near the refuse collection truck. Machinery then lifts the cart, opens it, and empties the contents into the collection truck.

However, a problem arises when using the conventional carts with a PAYT system, because those carts are universally opaque. It is not practical then to charge the residents by the number of bags or by other measure of the waste being disposed of, because one cannot easily observe the refuse and determine its volume. To implement a program of this type using conventional carts, it would be necessary to have an human operator open each individual cart and count the contents, or at least observe the discharge of every cart to determine how much refuse the cart contained. This approach would be excessively labor intensive, and likely prone to error because of the awkward and repetitive steps involved. Forcing the workers to look through the refuse carts is an invasive process with respect to the residents, and may causes privacy concerns.

Because of the labor intensive and intrusive aspects of checking the refuse held in conventional carts, it is not likely that inspection of the collected refuse would be carried out effectively. The determination of how much each resident discards would thus not be accurate. Without ensuring compliance and correct charging of collection fees, PAYT programs would have little chance of success.

A solution adopted by many localities involves providing different size carts for use by the residents, and charging more or less depending on the size of the cart selected. A small fee can be charged for small carts, and higher fees for progressively larger carts. However, this approach has several drawbacks. For example, residents that opt for the larger carts have little incentive to recycle and conserve. Households typically do not generate the same amount of refuse every week, so that the selected cart is often too large or too small.

These multiple cart size option programs are much less effective in promoting recycling and conservation than are true PAYT programs. For example, the Massachusetts Department of Environmental Protection found that in 2005, refuse collection systems utilizing a true unit based pricing garnered about a 40% reduction in waste, compared to only about a 17%-23% reduction found nationally by the EPA, for a study in which all programs, including “multiple cart size option” programs were included. As a result, the Massachusetts DEP does not consider the latter programs eligible for grants.

The various exemplary embodiments of the present invention provide methods and systems of refuse collection which can make a PAYT or other unit pricing scheme efficient and successful. According to embodiments of the invention, the system includes using refuse bags with easily identifiable visual features, which may have a pre-selected size, in conjunction with a transparent container which allows the human worker to rapidly and easily determine the cart's contents. For example, the container may be sized to contain multiple full bags, which can be seen from outside the container. The container may be, for example, of generally the same size and shape as conventional refuse carts, and be able to contain up to the average maximum amount of refuse generated by the residents.

By using the transparent containers and visually distinctive, or visually identifiable bags according to embodiments of the invention, it is possible to implement an effective PAYT program with either an automated refuse collection system, or with traditional manual collection. In either case, it is not necessary for the workers to open each container to determine the amount or volume of refuse that is being collected. Instead, the workers simply glance at the container, for example as they roll it to the collection vehicle, and are able to visually determine that the refuse bags being used are of the approved type. This can be done with sufficient accuracy to effectively administer the program, with essentially no increase in workload, and without giving the appearance of invading the privacy of the residents. For example, the cost of the refuse collection program may be included in the price of the bags, so that the residents pay for the program by buying the number of bags they need.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view showing a first embodiment of a cart according to the present invention; and

FIG. 2 is a perspective view showing a second embodiment of a cart according to the present invention.

### DETAILED DESCRIPTION OF THE DRAWING

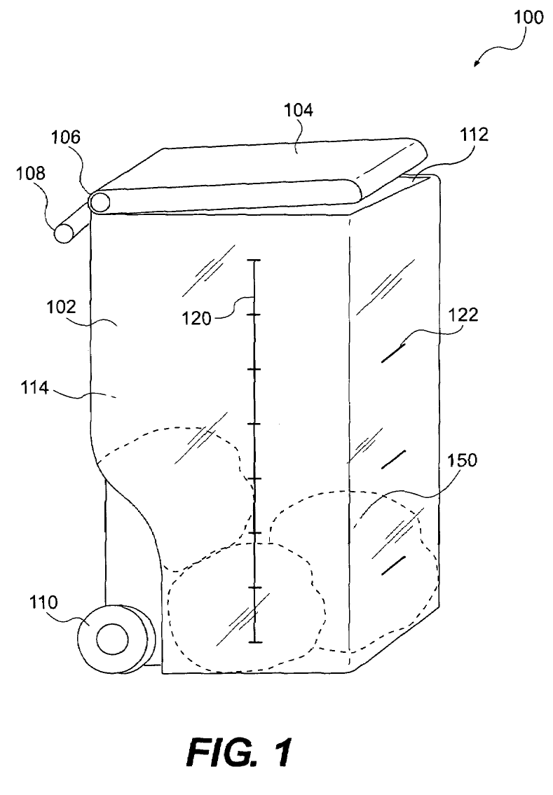

An exemplary embodiment of a container which may be used in a PAYT refuse collection program is sown in FIG. 1. In this embodiment, the container is a cart 100 which in outer dimensions and holding volume may be generally similar to conventional carts used for automated municipal refuse removal. The exemplary cart 100 has a body 102, which in this case has a generally quadrilateral cross section forming a shell and defining an internal cavity 114. In other embodiments, the cart 100 may have different shapes, such as a shorter and wider quadrilateral, a more rounded cross section, a different polygonal cross section, etc., based on operating constraints. For example, the equipment used to automatically load the refuse into the refuse collection vehicle may dictate the shape of the cart 100.

An openable lid 104 is provided, for example connected by a hinge 106 to the shell forming the cart's body, to allow the residents to load refuse in the cavity 114. In a preferred embodiment, the refuse is first packaged in unit bags 150, may have a pre-selected full volume. More importantly, bags 150 have one or more unique visual characteristics that make them appear different from generally available refuse bags, so that it is easy to establish that the correct bags have been used by the residents, simply by visually identifying the bags. The bags 150 may be manufactured of a conventional plastic material, and may be colored of a characteristic color for ease of identification and evaluation of refuse quantity. For example, the bags 150 may be colored red, orange yellow or other high contrast color easily visible by the operators through transparent walls while the refuse is handled in the cart 100. The color may preferably be uncommon to generic refuse bags, to give the workers confidence that the bags being counted are of the correct type. For example, bags 150 may be sold at a price which includes the cost of the refuse collection service, resulting in a higher fee being paid by residents that use more bags, i.e. throw out more garbage. Using visually identifiable bags may promote compliance with the collection program by discouraging the use of unapproved bags whose price does not include the cost of the collection service. The bags 150 may be conveniently sized to hold a substantial amount of refuse, while being easy to handle when full by an average resident.

In this exemplary embodiment, all sides of the cart 100 are formed of a substantially transparent material. For some applications, it may be sufficient to use a translucent material, which allows the evaluation of the volume of the contents, but not necessarily observation of additional detail thereof. In general, the transparent portions of the cart 100 need only be sufficiently transparent for the workers to be able to evaluate the amount of refuse contained in the cart, commensurate with the accuracy required by the specific refuse removal program.

Various elements that are common to refuse collection carts may be included in the exemplary cart 100. For example, a handle 108 and wheels 110 may be mounted in a conventional manner. The handle 108 or other portion of cart 100 may also be adapted for connection with an automated equipment of the refuse removal vehicle, to move and lift the cart 100 so it can be discharged with minimal handling by the worker. The material used to form part or all of the exemplary cart 100 may be a type of Polyolefin, such as, for example, LDPE, LLDPE, HDPE or polypropylene. The materials may contain a UV stabilizer, to maintain the transparency after being exposed to sunlight.

In one embodiment, the exemplary cart 100 may be manufactured using a rotational or injection molding process. The cart 100 may include a unitary shell with a lid defining the cavity 114. However, other conventional manufacturing methods may be used. All sides of the cart 100 shown in FIG. 1 are formed of the substantially transparent material, however, other embodiments may use only one or some see-through sides, with the remaining sides made of a conventional opaque material.

In different embodiments according to the invention, it may be useful to estimate the amount of refuse contained in the cart 100. In those exemplary embodiments, one or more indicia used to help determine the amount of refuse within the cart 100 may be provided. These indicia are appropriately located to help the operator rapidly and accurately evaluate the cart's contents. For example, a graduated scale 120 may be provided on one or more sides of the cart 100, so that the level to which the refuse rises within the cavity 114 may be read directly. Alternatively, other indicia may be used, such as the discrete marks 122. In this case, the indicia makes it easy to determine if certain levels within the cavity 114 have been reached. For example, in a system where a four tier pricing scheme is employed, three marks 122 may be placed on the cart 100 to visually indicate when each tier is reached by the refuse level.

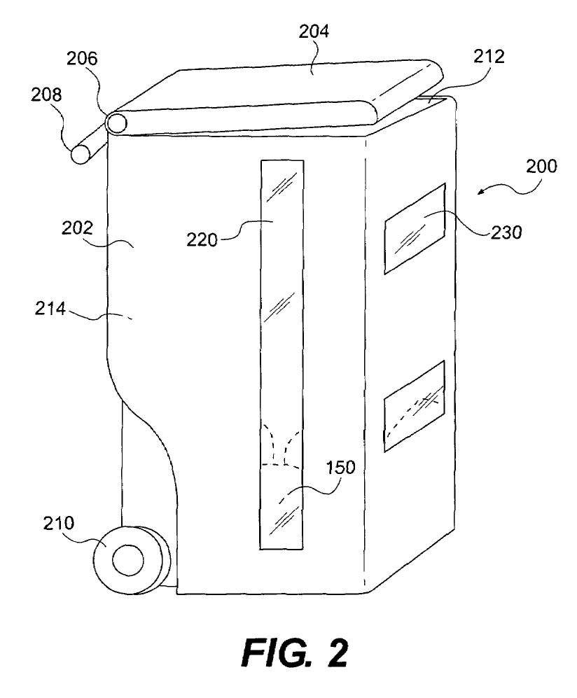

Another embodiment of the invention is shown in FIG. 2. The exemplary cart in this case is not completely made of transparent or translucent material, but rather is made of conventional opaque material fitted with transparent windows. The cart 200 may be, for example, similar to a conventional municipal refuse collection cart, having sides defining a cavity 214, a lid 212 connected via a hinge 206, a handle 208 and wheels 210. A transparent window 220 may be provided on one or more sides of the cart 200 to visually determine the level of refuse bags 150 contained therein, as well as to establish that the correct bags were used. The window 220 may be oriented appropriately to show the contents, for example along the long axis of the cart 200.

Alternatively, the cart 200 may have a few small windows built into one or more of its sides, to determine whether the refuse bags 150 within have reached selected levels. For example, two or more windows 230 may be used, so that the worker may easily determine whether the discarded refuse reaches pre-selected levels, and thus charge the resident accordingly.

The use of the exemplary cart according to embodiments of the invention is well suited to an automated refuse collection system. For example, the contents of the cart may be evaluated by a worker of a refuse collection vehicle by simply looking at the cart while moving it to the vehicle and connecting it to the automated equipment of the vehicle. As indicated above, a more or less accurate reading may be performed, depending on how the PAYT system is structured. A scale such as scale 120 may be used if an accurate reading is needed, or a marker 122 or window 230 may be used if a lower accuracy is sufficient. Alternatively, to ensure compliance with the refuse collection system, it may be sufficient to determine that the correct type of bag was used by the resident.

Once the estimated number of bags 150 or other measure of the refuse being removed is available, in one exemplary embodiment the data can be correlated to identifiers of the resident in any known manner, so that the resident can be billed correctly. For example, the resident may be identified by address, location along the route of the refuse removal vehicle, location data from a system such as GPS, electronic identifier of the residence, or any other method which can interface with a database of the residents utilizing the service. The worker can easily specify the amount of refuse, for example by entering the data into a recording or transmitting system using a keyboard, a dedicated input device, voice commands or other input device. Any system which allows the operator to specify the amount of refuse without significant addition of labor may be used for this purpose.

In exemplary systems where the cost of the program is paid by the residents by buying the special visually identifiable bags, the refuse removal operator has only to verify that the special bags have been used. To ensure compliance with the system, for example by identifying the unique visual features of the bags when collecting them.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for unit-based refuse collection, comprising:
providing a user with visually distinctive bags to contain the refuse to be collected;
providing the user with a container for holding wholly or partially filled visually distinctive bags while awaiting collection, the container having at least one substantially transparent portion for observing the filled visually distinctive bags therein; and
while collecting the refuse, visually determining compliance with usage of the visually distinctive bags by recognizing visual characteristics of the visually distinctive bags through the at least one substantially transparent portion.

2. The method according to claim 1, further comprising pricing the visually distinctive bags at a price including a cost of refuse collection.

3. The method according to claim 1, further comprising collecting the refuse by loading the container on a refuse collection vehicle with an automated apparatus.

4. The method according to claim 1, further comprising observing the visually distinctive bags in the container, every surface of the container being substantially transparent.

5. The method according to claim 1, further comprising observing the visually distinctive bags through a substantially transparent window formed in a side of the container.

6. The method according to claim 1, further comprising using a graduated scale of the container for visual determination of a refuse quantity.

7. The method according to claim 1, further comprising observing the visually distinctive bags against discrete marks of the container for visual determination of a refuse quantity.

8. The method according to claim 1, further comprising providing the visually distinctive bags with a high contrast color.

9. The method according to claim 1, further comprising forming containers of at least one of Polyolefin, LDPE, LLDPE, HDPE and polypropylene.

10. The method according to claim 1, further comprising charging the user a refuse collection fee based at least in part on a determined quantity of refuse collected.

11. The method according to claim 1, further comprising, for the visual determination, observing a distinctive color of the visually distinctive bags collected.

12. The method according to claim 1, further comprising, for the visual determination of a refuse quantity, observing a level of the visually distinctive bags relative to calibrated marks.

13. A system for unit-based refuse collection, comprising:
visually identifiable bags for containing refuse generated by a user, the visually identifiable bags having dimensions to be easily handled by the user;
a container adapted for holding a plurality of filled visually identifiable bags while awaiting collection, the container having at least one substantially transparent portion for observing the filled visually identifiable bags therein and for visually determining compliance with the unit-based system by recognizing visual characteristics of the filled visually identifiable bags therethrough; and
a lid portion of the container, openable by the user, for loading in the container the filled visually identifiable bags.

14. The system according to claim 13, wherein the container comprises a unitary, substantially transparent shell defining a cavity.

15. The system according to claim 13, wherein the container comprises measuring indicia to facilitate determination of an amount of collected refuse.

16. The system according to claim 13, wherein the container comprises substantially transparent windows adapted for observing the filled visually identifiable bags therein.

17. The system according to claim 13, wherein the container further comprises elements for attaching to an automated equipment of a refuse collection vehicle.

18. A container for a unit-based refuse collection system, adapted for holding a plurality of filled visually identifiable bags while awaiting collection, the bags being fillable with refuse generated by a user, the container having at least one substantially transparent portion for observing the filled visually identifiable bags therein and for visually determining compliance with the unit-based system by recognizing visual characteristics of the visually identifiable bags in the container.

19. The container according to claim 18, further comprising a lid portion of the container, openable by the user, for loading in the container the filled visually identifiable bags.

20. The container according to claim 18, further comprising calibrated indicia for facilitating determination of an amount of collected refuse.

21. The container according to claim 18, further comprising windows for observing the filled visually identifiable bags therein.
